(19) United States
(12) Patent Application Publication
(10) Pub. No.: US 2026/0159632 A1
(43) Pub. Date: Jun. 11, 2026

(54) POLYURETHANE RESIN AND POLYURETHANE FILM

(71) Applicant: CPC CORPORATION, TAIWAN, Kaohsiung City (TW)

(72) Inventors: CHING-FA CHI, Chia-Yi City (TW); CHENG-PO KUO, Hsinchu City (TW); YING-CHIEH YANG, Chia-Yi City (TW); CHYI-LIUH HO, Chia-Yi City (TW); JANN-CHEN LIN, Chia-Yi City (TW)

(73) Assignee: CPC CORPORATION, TAIWAN, Kaohsiung City (TW)

(21) Appl. No.: 19/008,642

(22) Filed: Jan. 3, 2025

(30) Foreign Application Priority Data
Dec. 5, 2024 (TW) 113147150

(51) Int. Cl. C08G 18/42; C08G 18/32; C08J 7/04

(52) U.S. Cl. CPC C08G 18/4244; C08G 18/3206; C08J 7/0427; C08J 2367/06; C08J 2475/04

(57) ABSTRACT

A polyurethane resin is made from a raw material including polycarbonate diol, diol and isocyanate; the polycarbonate diol includes repeating units as shown in formula (A) and (B), and the repeating units shown in formula (B) account for greater than 10 to 30 mol % of the polycarbonate diol.

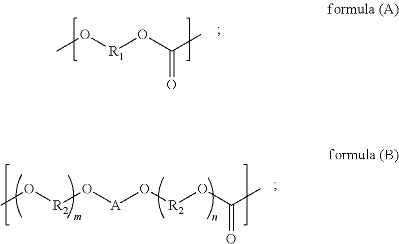

wherein, R₁ is a straight, branched, or cyclic C2-20 alkylene group; R₂ is a straight or branched C2-10 alkylene group, m and n are integers from 0 to 10 respectively, and m+n≥1, A is a C3-20 alicyclic hydrocarbon or a structure shown in formula (C):

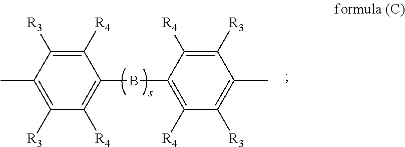

wherein, R₃ and R₄ are each independently a hydrogen atom or a C1-6 alkyl group; S is 1; and B is selected from:

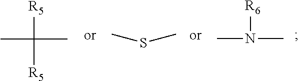

wherein, R₅ and R₆ are each independently a hydrogen atom or a C1-12 hydrocarbon group.

### CROSS-REFERENCE TO RELATED APPLICATION

This non-provisional application claims priority under 35 U.S.C. § 119 (a) on Patent Application No(s). 113147150 filed in Taiwan, R.O.C. on Dec. 5, 2024, the entire contents of which are hereby incorporated by reference.

### BACKGROUND OF THE INVENTION

### 1. Field of the Invention

The present disclosure relates to a polyurethane resin and a polyurethane film made by using the polyurethane resin.

### 2. Description of the Related Art

Polyurethane resin refers to a polymer material with a carbamate structure, which is mainly generated by the reaction of isocyanate functional group (—N═C═O) and hydroxyl group (—OH). In commercial manufacturing, polyurethanes are typically produced by reacting isocyanates with a mixture including polyols and catalysts, etc.

As far as polyols used in the manufacture of polyurethane are concerned, it has been proposed to use polycarbonate diol as a polyol, which is an oligomer with hydroxyl groups at both ends of the molecule, mainly used in the preparation of soft segments in polyurethane, and the polyurethane made by it is mainly used in thermoplastic elastomers and foaming materials.

For example, Taiwan invention patent TWI673298B discloses a polycarbonate diol and a polyurethane foam made from the polycarbonate diol; in this way, polyurethane foam with high specific strength (foaming ratio×compression strength) can be produced.

### BRIEF SUMMARY OF THE INVENTION

However, the above-mentioned Taiwan invention patent TWI673298B is mainly aimed at the use of polycarbonate diol to manufacture polyurethane foam materials, and it fails to explain the polyurethane film with high elastic modulus. More specifically, the above-mentioned patent document extensively discloses that the molar ratio of formula (A) and formula (B) in polycarbonate diol is in the range of 1:99 to 99:1, and the effect of molar ratio of formula (A) and formula (B) on the elastic modulus of polyurethane film is not discussed.

Therefore, there is still room for improvement in polyurethane resins suitable for making polyurethane films with high elastic moduli.

In order to solve the above-mentioned problem, a polyurethane resin of an aspect of the present disclosure is characterized in that: the polyurethane resin is made from a raw material including polycarbonate diol, diol and isocyanate; the polycarbonate diol includes repeating units as shown in formula (A) and formula (B) below, and the repeating units shown in formula (B) account for greater than 10 mol % to 30 mol % of the polycarbonate diol;

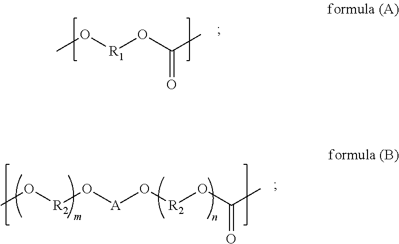

In formula (A), R₁ is a straight, branched, or cyclic C2-20 alkylene group; in formula (B), R₂ is a straight or branched C2-10 alkylene group, m and n are integers from 0 to 10 respectively, and m+n≥1, A is a C3-20 alicyclic hydrocarbon or a structure shown in formula (C) below;

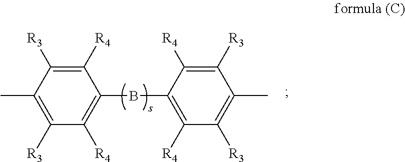

In formula (C), R₃ and R₄ are each independently a hydrogen atom or a C1-6 alkyl group; S is 1; and B is selected from:

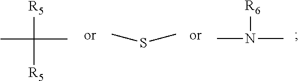

wherein, R₅ and R₆ are each independently a hydrogen atom or a C1-12 hydrocarbon group.

In one embodiment, the diol is selected from at least one group consisting of propanediol, butanediol, pentanediol and hexanediol.

In one embodiment, a molar ratio of the polycarbonate diol to the diol is 8:2 to 2:8.

In one embodiment, the number average molecular weight (Mn) of the polycarbonate diol is 500 to 5000.

In one embodiment, in formula (A), R₁ is butylene or hexylene.

In one embodiment, in formula (B), R₂ is a C2-3 alkylene group.

In one embodiment, in formula (B), A is

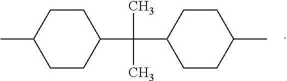

In one embodiment, in formula (B), 1≤m+n≤10.

In one embodiment, the repeating unit of formula (B) accounts for 14.5 mol % to 25 mol % of the polycarbonate diol.

In order to solve the above-described problem, the polyurethane film of an aspect of the present disclosure is made of the polyurethane resin, and an elastic modulus of the polyurethane film is greater than 90 MPa.

An aspect of the present disclosure is completed in view of the above-mentioned problem point of prior art, and the object is to provide a polyurethane resin, which is suitable to prepare a polyurethane film having a high elastic modulus.

### BRIEF DESCRIPTION OF THE DRAWINGS

None

### DETAILED DESCRIPTION OF THE INVENTION

The implementation of the present disclosure is illustrated by the specific embodiments as follows, so one skilled in the art may understand other advantages and effects of the present disclosure by the contents disclosed in the specification. The present disclosure may also be implemented or applied by other embodiments, and the details in the specification may also be modified and varied based on different views and applications without departing from the spirit of the present disclosure.

Unless otherwise specified herein, the term “A-B” used in the specification and the claims attached includes the meaning of “A or more and B or less”. For example, the term “10-40 wt %” includes the meaning of “10 wt % or more and 40 wt % or less”.

First, the polyurethane resin of the present disclosure is made from polycarbonate diol, diol and isocyanate that are liquid at room temperature as necessary raw materials. The following is a detailed description of each ingredient.

### [Polycarbonate Diol]

The polycarbonate diol includes two repeating units from the diol in formula (A) and formula (B), wherein the repeating unit in formula (B) is from alkoxylated cyclic diol monomers, and formula (B) accounts for greater than 10 mol % to 30 mol % of the polycarbonate diol, preferably 14.5 mol % to 25 mol %, most preferably 20 mol %.

Among them, formula (A) is

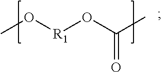

and in formula (A), R₁ is a straight, branched, or cyclic C2-20 alkylene group; according to some embodiments, R₁ may be butylene or hexylene, such as n-butylene, tert-butylene, n-hexylene, sec-hexylene.

Also, formula (B) is

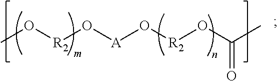

and in formula (B), R₂ is a straight or branched C2-10 alkylene group, m and n are integers from 0 to 10 respectively, and m+n≥1, A is a C3-20 alicyclic hydrocarbon or a structure shown in formula (C) below;

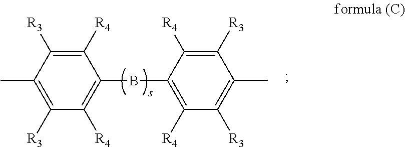

In formula (C), R₃ and R₄ are each independently a hydrogen atom or a C1-6 alkyl group; S is 1; and B is selected from:

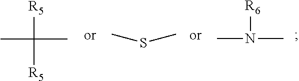

wherein, R₅ and R₆ are each independently a hydrogen atom or a C1-12 hydrocarbon group.

Specifically, R₂ in formula (B) may be a C2-3 alkylene group, such as ethylene, propylene. Also, in formula (B), m+n≥1 to ≤20, and more preferably 1≤m+n≤10. In addition, A in formula (B) may be

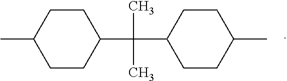

In some embodiments, alkoxylated diol monomers used to form the repeating units as shown in formula (B) includes: 2-bis[4-(2-hydroxyethoxy)cyclohexyl]-propane, 2-bis[4-(2-hydroxyethoxy)phenyl]-propane, 2-[4-(2-hydroxyethoxy)cyclohexyl]-2-[4-(2-hydroxydiethoxy)cyclohexyl]-propane or 2-[4-(2-hydroxyethoxy)phenyl]-2-[4-(2-hydroxydiethoxy)phenyl]-propane. More specifically, the alkoxylated diol monomers used to form the repeating units as shown in formula (B) have a structure as shown in formula (E) below:

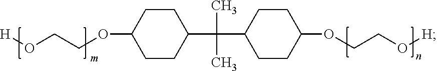

wherein, m and n in formula (E) are both equal to 1, and in the following embodiment, HBPA-EO₂ is used to represent the structure shown in formula (E).

Herein, polycarbonate diol can be prepared by the following steps. First, a transesterification reaction can be carried out using diol monomer and dialkyl carbonate to separate the hydroxyl-containing compound from the dialkyl carbonate, in order to obtain a polycarbonate prepolymer. Next, compounds that still include hydroxyl groups, unreacted diol monomers, unreacted dialkyl carbonate, etc., are removed, and the polycarbonate prepolymer carries out a condensation reaction to obtain polycarbonate diol.

Also, according to some embodiments of the present disclosure, the aforementioned transesterification reaction is carried out using diol monomers, the above-mentioned alkoxylated cyclic diol monomers and dialkyl carbonate, in order to form polycarbonate diol having two repeating units of formula (A) and formula (B). Among them, the diol monomer may have a structure shown in formula (D).

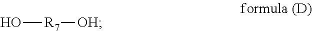

In formula (D), R₇ may be a straight, branched or cyclic C2-C20 alkylene group, such as butylene or hexylene. For example, diol monomers with a structure of formula (D) may include ethylene glycol, 1,2-propanediol, 1,3-propanediol, neopentyl glycol, 1,4-butanediol, 2-isopropyl-1,4-butanediol, 1,5-pentanediol, 1,8-octandiol, 1,9-nonanediol, 1,10-decanediol, 1,3-cyclohexanediol, 1,4-cyclohexanediol, 1,4-cyclohexanedimethanol or 2-bis(4-hydroxycyclohexyl)-propane.

In addition, the dialkyl carbonate used for the aforementioned transesterification reaction may include dimethyl carbonate, diethyl carbonate, dipropyl carbonate or dibutyl carbonate. According to some embodiments of the present disclosure, dimethyl carbonate is used to carry out the transesterification reaction.

In some embodiments, the number average molecular weight (Mn) of polycarbonate diol is 500 to 5000, preferably 800 to 1500.

### [Diol]

Diol is used as a necessary ingredient for the preparation of polyurethane resin, mainly used as a chain extender, which can use a diol selected from at least one group consisting of propanediol, butanediol, pentanediol and hexanediol. Butanediol (BDO) is used in some embodiments of the present disclosure, which is a small molecule (molecular weight of 90.1 g/mol), and there is no ether group in the molecule, which is suitable for use as a chain extender. Also, a molar ratio of the above-mentioned polycarbonate diol to diol is preferably between 8:2 and 2:8.

### [Isocyanate]

Isocyanate is used as a necessary ingredient in the preparation of polyurethane resin, mainly used as a hardener, and it can use traditional diisocyanates, such as toluene diisocyanate, 4,4′-diphenylmethane diisocyanate. 4,4′-diphenylmethane diisocyanate (MDI) is used in some embodiments of the present disclosure. Also, in some embodiments, a molar ratio of the above-mentioned polycarbonate diol to isocyanate is about 0.55:1.

### (Method for Manufacturing Polyurethane Resin)

As a method for manufacturing the polyurethane resin, it can be listed as a method for preparation by placing polycarbonate diol and diol together in a solvent and dissolving them evenly, and then adding isocyanate for reaction, and the reaction is preferably carried out at a temperature of 30-100° C. for 0.5-10 hours. Also, the reaction can be carried out in a mixed solvent of dimethylformamide/toluene/butanone.

### (Method for Manufacturing Polyurethane Film)

As a method for manufacturing the polyurethane film, it can be listed as a method for preparation by coating the obtained polyurethane resin solution on a PET release film with a 300 μm scraper, and after drying in an oven at 80° C. for 24 hours, a polyurethane film with a thickness of 50-60 μm can be obtained. In the embodiment of the present disclosure, the elastic modulus of the polyurethane film is greater than 90 MPa, more preferably greater than 200 MPa, and most preferably greater than 500 MPa.

### EMBODIMENTS

Below, although the present disclosure is specifically described by various embodiments and comparative examples, the present disclosure is not limited to such embodiments and comparative examples.

### [Hydroxyl Value of Polycarbonate Diol (OH Value)]

According to the ASTM E1899 standard, the titration mode is set to DET mode, the electrode model is Solvotrode easyClean 6.0229.010 from Metrohm, and the titration solution is made from 0.1 M tetrabutylammonium hydroxide (TBAOH) in isopropanol (IPA)/methanol (MeOH) (50/50 v/v) solution, and P-toluenesulfonyl fluoride isocyanate (TSI) solution is prepared (adding about 250 ml of acetonitrile to a 500 ml volumetric flask, then adding 20 ml of TSI, then adding acetonitrile to scale line of 500 ml and mixing evenly), TBAOH solution is calibrated (after adding 180 mg of potassium hydrogen phthalate (KHP) to 60 ml of deionized water to be dissolved, titrating with 0.1M TBAOH), sample preparation is carried out (dissolving an appropriate amount of sample in 10 ml acetonitrile, then adding 10 ml TSI solution and stirring, then adding 0.5 ml of deionized water and stirring, and finally adding 40 ml of acetonitrile), and finally the hydroxyl value of the sample is obtained by automatically titrating.

### [Number Average Molecular Weight of Polycarbonate Diol]

$$Number average molecular weight ( Mn ) = 2 / hydroxyl value \times {10}^{- 3} / 56 \text{.11} )$$

### [Tensile Testing of Polyurethane (PU) Film]

The mechanical properties of the PU film are measured by using a universal material testing machine according to ASTM D882 standards for film (thickness ≤100 μm) materials, mainly including the tensile strength (maximum stress), elongation at break and elastic modulus of the material, etc., to evaluate and compare the tensile resistance and applicable range of the material. A long strip standards test piese is used, with a size of 150 mm×12.5 mm, a clamp spacing of 100 mm, and a clamp separation speed of 50 mm/min.

### [Tests of Acid Resistance, Alkali Resistance and Hydrolysis Resistance of PU Film]

After the PU film specimen is cut to an appropriate size according to the container containing the solution, the tests of water resistance, acid resistance and alkali resistance are carried out according to the following conditions.
a. Water resistance test: soaking in a water bath at 100° C. for 24 hr;
b. Acid resistance test: soaking in 0.1M H₂SO₄ for 24 hr;
c. Alkali resistance test: soaking in 0.1M NaOH for 24 hr.
wherein, in Table 5 below, ∘ represents no change in weight (no decomposition) and no damage in appearance; Δ represents no change in weight (no decomposition), but slight warping deformation in appearance; X represents no change in weight (no decomposition), but the appearance is severely warped, deformed and sticky.

### [Preparation of Polycarbonate Diol]

### Embodiment 1

In a glass round-bottom flask equipped with a mixer, a thermometer, a nitrogen gas introduction tube and an exhaust gas condensing system, 1371 g of dimethyl carbonate (DMC), 1111 g of 1,4-butanediol (BDO), 450 g of ethoxylated-2-bis(4-hydroxycyclohexyl)-propane (hereinafter referred to as HBPA-EO₂) and 137 mg of tetrabutoxytitanium catalyst are fed, the feeding in the round-bottom flask are stirred under normal pressure with nitrogen purge, and while the mixture of by-product methanol and dimethyl carbonate are distilled off, a transesterification is carried out for 14 hours. During this process, the reaction temperature is progressively increased from 120° C. to 170° C.

Next, the reaction pressure is reduced to 10 torr, and while the by-product methanol, unreacted dimethyl carbonate and unreacted BDO are distilled off at 180° C., a condensation reaction is carried out for 10 hours simultaneously. After the reaction is completed, the reaction solution is cooled to room temperature to obtain 997 g of a viscous liquid product, that is, a polycarbonate diol copolymer PC-1 of Embodiment 1. According to the above test method, the obtained polycarbonate diol copolymer PC-1 is determined, the number average molecular weight is 883, the hydroxyl value is 127 mg KOH/g, and HBPA-EO₂ accounts for 14.5 mol % of polycarbonate diol.

### Embodiment 2

Except for changing the feeding to 1219 g of dimethyl carbonate (DMC), 933 g of 1,4-butanediol (BDO), 600 g of ethoxylated-2-bis(4-hydroxycyclohexyl)-propane (HBPA-EO₂) and 129 mg of tetrabutoxytitanium catalyst, the same procedure is carried out as in Embodiment 1 to obtain 1115 g of a viscous liquid, that is, a polycarbonate diol copolymer PC-2 of Embodiment 2. Next, according to the above test method to determine PC-2, the number average molecular weight thereof is 850, the hydroxyl value is 132 mg KOH/g, and HBPA-EO₂ accounts for 20.0 mol % of polycarbonate diol.

### Embodiment 3

Except for changing the time of the condensation reaction to 11 hours to further remove the BDO to control the molecular weight of the polycarbonate diol copolymer, the same procedure is carried out as in Embodiment 2 to obtain 1113.6 g of a viscous liquid, that is, a polycarbonate diol copolymer PC-3 of Embodiment 3. Next, according to the above test method to determine PC-3, the number average molecular weight thereof is 1122, the hydroxyl value is 100 mg KOH/g, and HBPA-EO₂ accounts for 20.0 mol % of polycarbonate diol.

### Embodiment 4

Except for changing the feeding to 92 g of dimethyl carbonate (DMC), 70 g of 1,4-butanediol (BDO), 45 g of ethoxylated-2-bis(4-hydroxycyclohexyl)-propane (HBPA-EO₂) and 10.2 mg of tetrabutoxytitanium catalyst, the same procedure is carried out as in Embodiment 1 to obtain 85 g of a viscous liquid, that is, a polycarbonate diol copolymer PC-4 of Embodiment 4. Next, according to the above test method to determine PC-4, the number average molecular weight thereof is 1181, the hydroxyl value is 95 mg KOH/g, and HBPA-EO₂ accounts for 24.2 mol % of polycarbonate diol.

### Embodiment 5

Except for changing the feeding to 69 g of dimethyl carbonate (DMC), 50 g of 1,4-butanediol (BDO), 45 g of ethoxylated-2-bis(4-hydroxycyclohexyl)-propane (HBPA-EO₂) and 10.2 mg of tetrabutoxytitanium catalyst, the same procedure is carried out as in Embodiment 1 to obtain 65 g of a viscous liquid, that is, a polycarbonate diol copolymer PC-5 of Embodiment 5. Next, according to the above test method to determine PC-5, the number average molecular weight thereof is 1496, the hydroxyl value is 75 mg KOH/g, and HBPA-EO₂ accounts for 30.3 mol % of polycarbonate diol.

### Comparative Example 1

In a glass round-bottom flask equipped with a rectifying tower, a mixer, a thermometer, a nitrogen gas introduction tube and an exhaust gas condensing system, 963 g of dimethyl carbonate (DMC), 1200 g of 1,6-hexanediol (hereinafter referred to as HDO) and 51 mg of tetrabutoxytitanium catalyst are fed, the feeding in the round-bottom flask are stirred under normal pressure with nitrogen purge, and while the mixture of by-product methanol and dimethyl carbonate are distilled off, a transesterification is carried out for 38 hours. During this process, the reaction temperature is progressively increased from 120° C. to 160° C.

Subsequently, the reaction pressure is slowly reduced to 10 torr, and while the mixture of unreacted methanol and dimethyl carbonate and unreacted HDO are distilled off under stirring, a condensation reaction is further carried out at 180° C. for 27 hours simultaneously. After the reaction is completed, the reaction solution is cooled to room temperature to obtain 932 g of a solid polycarbonate diol copolymer PC-S1 of Comparative example 1. Next, according to the above test method to determine PC-S1, the number average molecular weight thereof is 1122, the hydroxyl value is 100 mg KOH/g.

### Comparative Example 2

In a glass round-bottom flask equipped with a rectifying tower, a mixer, a thermometer, a nitrogen gas introduction tube and an exhaust gas condensing system, 1930 g of dimethyl carbonate (DMC), 1202 g of 1,6-hexanediol (HDO), 1060 g of 1,5-pentanediol (hereinafter referred to as PDO) and 67 mg of tetrabutoxytitanium catalyst are fed, the feeding in the glass round-bottom flask are stirred under normal pressure with nitrogen purge, and while the mixture of by-product methanol and dimethyl carbonate are distilled off, a transesterification is carried out for 20 hours. During this process, the reaction temperature is progressively increased from 120° C. to 160° C.

Subsequently, the reaction pressure is slowly reduced to 10 torr, and while the mixture of unreacted methanol and dimethyl carbonate and unreacted HDO and PDO are distilled off under stirring, a condensation reaction is further carried out at 180° C. for 7 hours simultaneously. After the reaction is completed, the reaction solution is cooled to room temperature to obtain 1066 g of a liquid polycarbonate diol copolymer PC-S2 of Comparative example 2. Next, according to the above test method to determine PC-S2, the number average molecular weight thereof is 1001, the hydroxyl value is 112 mg KOH/g.

### Comparative Example 3

Except for changing the feeding to 1219 g of dimethyl carbonate (DMC), 1050 g of 1,4-butanediol (BDO), 300 g of ethoxylated-2-bis(4-hydroxycyclohexyl)-propane (HBPA-EO₂) and 129 mg of tetrabutoxytitanium catalyst, the same procedure is carried out as in Embodiment 1 to obtain 1115 g of a viscous liquid, that is, a polycarbonate diol copolymer PC-6 of Comparative example 3. Next, according to the above test method to determine PC-6, the number average molecular weight thereof is 1020, the hydroxyl value is 110 mg KOH/g, and HBPA-EO₂ accounts for 10.0 mol % of polycarbonate diol.

### Comparative Example 4

Except for changing the feeding to 55 g of dimethyl carbonate (DMC), 38 g of 1,4-butanediol (BDO), 45 g of ethoxylated-2-bis(4-hydroxycyclohexyl)-propane (HBPA-EO₂) and 6.4 mg of tetrabutoxytitanium catalyst, the same procedure is carried out as in Embodiment 1 to obtain 62 g of a viscous liquid, that is, a polycarbonate diol copolymer PC-7 of Comparative example 4. Next, according to the above test method to determine PC-7, the number average molecular weight thereof is 927, the hydroxyl value is 121 mg KOH/g, and HBPA-EO₂ accounts for 52.6 mol % of polycarbonate diol.

Next, the experimental results of the above Embodiments 1-5 and Comparative examples 1˜4 are sorted out in Table 1 and Table 2.

TABLE 1

| | E1 | E2 | E3 | E4 | E5 |
|---|---|---|---|---|---|
| Polycarbonate | PC-1 | PC-2 | PC-3 | PC-4 | PC-5 |
| diol | | | | | |
| Diol monomer | HBPA- | HBPA- | HBPA- | HBPA- | HBPA- |
| composition | EO₂/ | EO₂/ | EO₂/ | EO₂/ | EO₂/ |
| | BDO | BDO | BDO | BDO | BDO |
| Hydroxyl value | 127 | 132 | 100 | 95 | 75 |
| (mg KOH/g) | | | | | |
| Number average | 883 | 850 | 1122 | 1181 | 1496 |
| molecular | | | | | |
| weight (Mn) | | | | | |
| mol % of HBPA- | 14.5 | 20.0 | 20.0 | 24.2 | 30.3 |
| EO₂ accounting | | | | | |
| for | | | | | |
| polycarbonate | | | | | |
| diol | | | | | |
| State at room | liquid | liquid | liquid | liquid | liquid |
| temperature | | | | | |

TABLE 2

| | CE1 | CE2 | CE3 | CE4 |
|---|---|---|---|---|
| Polycarbonate | PC-S1 | PC-S2 | PC-6 | PC-7 |
| diol | | | | |
| Diol monomer | HDO | HDO/PDO | HBPA- | HBPA- |
| composition | | | EO₂/BDO | EO₂/BDO |
| Hydroxyl value | 100 | 112 | 110 | 121 |
| (mg KOH/g) | | | | |
| Number average | 1122 | 1001 | 1020 | 927 |
| molecular | | | | |
| weight (Mn) | | | | |
| mol % of HBPA- | 0 | 0 | 10.0 | 52.6 |
| EO₂ accounting | | | | |
| for | | | | |
| polycarbonate | | | | |
| diol | | | | |
| State at room | solid | liquid | liquid | liquid |
| temperature | | | | |

It can be seen from the above Table 1-Table 2, by adding ethoxylated-2-bis(4-hydroxycyclohexyl)-propane (HBPA-EO₂) to polycarbonate diol, the crystallinity of 1,6-hexanediol or 1,4-butanediol can be destroyed, so that the polycarbonate diol obtained is liquid at room temperature, so it has preferable operational convenience when used in the production of polyurethane resin and film.

### [Preparation of Polyurethane Film]

### Embodiment 6

4 g of polycarbonate diol (PC-1) obtained in Embodiment 1 is taken, 0.27 g of BDO and 6.34 g of solvent (dimethylformamide/toluene/butanone=20/40/40) are added, and mixed evenly afterwards, and then 2.07 g of 4,4′-diphenylmethane diisocyanate (MDI) is added to react in a water bath at 75° C. for 1 hour. Then, the obtained polyurethane solution is coated on a PET release film with a 300 μm scraper, and after it is dried in an oven at 80° C. for 24 hours, a polyurethane film PU-1 with a thickness of 50 to 60 μm is obtained, after the polyurethane film PU-1 is cut, the tensile testing (ASTM D882) is carried out, and the results are shown in Table 3-Table 4.

### Embodiment 7

4 g of polycarbonate diol (PC-2) obtained in Embodiment 2 is taken, 0.28 g of BDO and 6.44 g of solvent (dimethylformamide/toluene/butanone=20/40/40) are added, and mixed evenly afterwards, and then 2.16 g of 4,4′-diphenylmethane diisocyanate (MDI) is added to react in a water bath at 75° C. for 1 hour. Then, the same procedure is carried out as in Embodiment 6 to obtain a polyurethane film PU-2 with a thickness of 50 to 60 μm, after the polyurethane film PU-2 is cut, the tensile testing is carried out, and the results are shown in Table 3-Table 4.

### Embodiment 8

4 g of polycarbonate diol (PC-3) obtained in Embodiment 3 is taken, 0.28 g of BDO and 6.44 g of solvent (dimethylformamide/toluene/butanone=20/40/40) are added, and mixed evenly afterwards, and then 1.64 g of 4,4′-diphenylmethane diisocyanate (MDI) is added to react in a water bath at 75° C. for 1 hour. Then, the same procedure is carried out as in Embodiment 6 to obtain a polyurethane film PU-3 with a thickness of 50 to 60 μm, after the polyurethane film PU-3 is cut, the tensile testing is carried out, and the results are shown in Table 3-Table 4.

### Embodiment 9

4 g of polycarbonate diol (PC-4) obtained in Embodiment 4 is taken, 0.15 g of BDO and 5.55 g of solvent (dimethylformamide/toluene/butanone=20/40/40) are added, and mixed evenly afterwards, and then 1.41 g of 4,4′-diphenylmethane diisocyanate (MDI) is added to react in a water bath at 75° C. for 1 hour. Then, the same procedure is carried out as in Embodiment 6 to obtain a polyurethane film PU-4 with a thickness of 50 to 60 μm, after the polyurethane film PU-4 is cut, the tensile testing is carried out, and the results are shown in Table 3-Table 4.

### Embodiment 10

4 g of polycarbonate diol (PC-5) obtained in Embodiment 5 is taken, 0.11 g of BDO and 5.15 g of solvent (dimethylformamide/toluene/butanone=20/40/40) are added, and mixed evenly afterwards, and then 1.05 g of 4,4′-diphenylmethane diisocyanate (MDI) is added to react in a water bath at 75° C. for 1 hour. Then, the same procedure is carried out as in Embodiment 6 to obtain a polyurethane film PU-5 with a thickness of 50 to 60 μm, after the polyurethane film PU-5 is cut, the tensile testing is carried out, and the results are shown in Table 3-Table 4.

### Comparative Example 5

4 g of polycarbonate diol (PC-S1) obtained in Comparative example 1 is taken, 0.21 g of BDO and 5.85 g of solvent (dimethylformamide/toluene/butanone=20/40/40) are added, and mixed evenly afterwards, and then 1.64 g of 4,4′-diphenylmethane diisocyanate (MDI) is added to react in a water bath at 75° C. for 1 hour. Then, the same procedure is carried out as in Embodiment 6 to obtain a polyurethane film PU-S1 with a thickness of 50 to 60 μm, after the polyurethane film PU-S1 is cut, the tensile testing is carried out, and the results are shown in Table 3-Table 4.

### Comparative Example 6

4 g of polycarbonate diol (PC-S2) obtained in Comparative example 2 is taken, 0.24 g of BDO and 6.07 g of solvent (dimethylformamide/toluene/butanone=20/40/40) are added, and mixed evenly afterwards, and then 1.83 g of 4,4′-diphenylmethane diisocyanate (MDI) is added to react in a water bath at 75° C. for 1 hour. Then, the same procedure is carried out as in Embodiment 6 to obtain a polyurethane film PU-S2 with a thickness of 50 to 60 μm, after the polyurethane film PU-S2 is cut, the tensile testing is carried out, and the results are shown in Table 3-Table 4.

### Comparative Example 7

Except for changing 4 g of the polycarbonate diol (PC-S2) used in Comparative example 6 to 4 g of the polycarbonate diol (PC-6) used in Comparative example 3, the same procedure is carried out as in Comparative example 6 to obtain a polyurethane film PU-6 with a thickness of 50 to 60 μm, after the polyurethane film PU-6 is cut, the tensile testing is carried out, and the results are shown in Table 3-Table 4.

### Comparative Example 8

4 g of polycarbonate diol (PC-7) obtained in Comparative example 4 is taken, 0.17 g of BDO and 5.93 g of solvent (dimethylformamide/toluene/butanone=20/40/40) are added, and mixed evenly afterwards, and then 1.72 g of 4,4′-diphenylmethane diisocyanate (MDI) is added to react in a water bath at 75° C. for 1 hour. The obtained polyurethane solution is coated on a PET release film with a 300 μm scraper, and then dried in an oven at 80° C. for 24 hours, but a film cannot be formed.

TABLE 3

| | E6 | E7 | E8 | E9 | E10 |
|---|---|---|---|---|---|
| Polycarbonate | PC-1 | PC-2 | PC-3 | PC-4 | PC-5 |
| diol | | | | | |
| mol % of HBPA- | 14.5 | 20.0 | 20.0 | 24.2 | 30.0 |
| EO₂ accounting | | | | | |
| for | | | | | |
| polycarbonate | | | | | |
| diol | | | | | |
| polyurethane | PU-1 | PU-2 | PU-3 | PU-4 | PU-5 |
| film | | | | | |
| elastic modulus | 98 | 566 | 540 | 337 | 209 |
| (MPa) | | | | | |

TABLE 4

| | CE5 | CE6 | CE7 | CE8 |
|---|---|---|---|---|
| Polycarbonate | PC-S1 | PC-S2 | PC-6 | PC-7 |
| diol | | | | |
| mol % of HBPA- | 0 | 0 | 10.0 | 52.6 |
| EO₂ accounting | | | | |
| for | | | | |
| polycarbonate | | | | |
| diol | | | | |
| polyurethane | PU-S1 | PU-S2 | PU-6 | a film |
| film | | | | cannot be |
| | | | | formed |
| elastic modulus | 22 | 16 | 30 | — |
| (MPa) | | | | |

It can be seen from the above Table 1-Table 4, referring to Embodiments 6 to 10, because HBPA-EO₂ of Embodiments 1 to 5 accounts for polycarbonate diol in the range of greater than 10 mol % to 30 mol %, so that the polycarbonate diol of Embodiments 1 to 5 can respectively prepare polyurethane film PU-1, PU-2, PU-3, PU-4 and PU-5 with elastic modulus of 98, 566, 540, 337 and 209 MPa. In contrast, referring to Comparative examples 5 to 6, because Comparative examples 1 to 2 use polycarbonate diol (e.g., 1,6-hexanediol) with general carbon chain aliphatic structure, the elastic moduli of the polyurethane films PU-S1 and PU-S2 prepared are respectively only 22 and 16 MPa, which fail to meet the requirements.

In addition, referring to Comparative example 7, the elastic modulus of Comparative example 3 is not significantly different from that of Comparative example 5 without adding HBPA-EO₂ because HBPA-EO₂ of Comparative example 3 accounts for 10 mol. % of polycarbonate diol, which shows that when the molar ratio of HBPA-EO₂ in polycarbonate diol is too low (10 mol. % or less), it fails to significantly contribute to the strength of the polyurethane film.

Next, referring to Comparative example 8, because HBPA-EO₂ of Comparative example 4 accounts for 52.6 mol. % of polycarbonate diol, which is greater than the scope of application of the present disclosure, the polyurethane film cannot be obtained.

It can be seen that polycarbonate diol containing the repeating unit of formula (B), and the content accounts for greater than 10 mol % to 30 mol % (preferably 14.5 mol % to 25 mol %) of polycarbonate diol, which has higher material rigidity, and its deformation is relatively small when the material occurs deformation under the action of external force, which is conducive to being applied to products with rigid requirements.

Finally, the polyurethane films of the above Embodiments 6 to 7 and Comparative example 5 are subjected to the above-mentioned tests of acid resistance, alkali resistance and hydrolysis resistance, and the results are shown in Table 5.

TABLE 5

| | E6 | E7 | CE5 |
|---|---|---|---|
| Polycarbonate diol | PC-1 | PC-2 | PC-S1 |
| mol % of HBPA-EO₂ | 14.5 | 20.0 | 0 |
| accounting for | | | |
| polycarbonate diol | | | |
| Polyurethane film | PU-1 | PU-2 | PU-S1 |
| Water bath at 100° C. | Δ | Δ | X |
| Sulfuric acid solution | ◯ | ◯ | ◯ |
| (0.1M) | | | |
| Sodium hydroxide | ◯ | ◯ | ◯ |
| solution (0.1M) | | | |

It can be seen from Table 5 that although the polyurethane film prepared from polycarbonate diol from three different sources has a certain degree of hydrolysis resistance, acid resistance and alkali resistance, after immersion in hot water at 100° C., the polyurethane film (PU-S1) prepared from aliphatic polycarbonate diol has been seriously deformed and sticky, and the result is X; however, the polyurethane films (PU-1 and PU-2) prepared from polycarbonate diol containing a specific proportion of HBPA-EO₂ have only slight warping, and the result is A, indicating that the polyurethane film prepared from polycarbonate diol containing a specific proportion of HBPA-EO₂ has preferable temperature tolerance.

The present invention is not limited to the above-mentioned embodiments, and various changes may be made within the scope indicated in the claims, and the embodiments obtained by appropriately combining the technical means disclosed in the different embodiments are also included in the technical scope of the present invention.

While the present disclosure has been described by means of specific embodiments, numerous modifications and variations could be made thereto by those skilled in the art without departing from the scope and spirit of the present disclosure set forth in the claims.

What is claimed is:

1. A polyurethane resin, characterized in that:
the polyurethane resin is made from a raw material comprising polycarbonate diol, diol and isocyanate;
the polycarbonate diol comprises repeating units as shown in formula (A) and formula (B) below, and the repeating units shown in formula (B) account for greater than 10 mol % to 30 mol % of the polycarbonate diol; 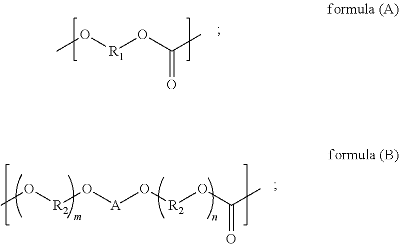
in formula (A), R₁ is a straight, branched, or cyclic C2-20 alkylene group;
in formula (B), R₂ is a straight or branched C2-10 alkylene group, m and n are integers from 0 to 10 respectively, and m+n≥1, A is a C3-20 alicyclic hydrocarbon or a structure shown in formula (C) below; 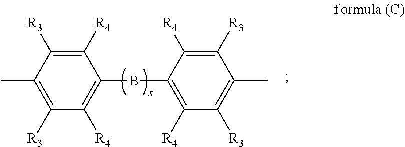
in formula (C), R₃ and R₄ are each independently a hydrogen atom or a C1-6 alkyl group; S is 1; and B is selected from: 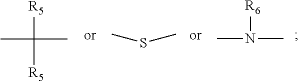
wherein, R₅ and R₆ are each independently a hydrogen atom or a C1-12 hydrocarbon group.

2. The polyurethane resin according to claim 1, wherein the diol is selected from at least one group consisting of propanediol, butanediol, pentanediol and hexanediol.

3. The polyurethane resin according to claim 1, wherein a molar ratio of the polycarbonate diol to the diol is 8:2 to 2:8.

4. The polyurethane resin according to claim 1, wherein the number average molecular weight (Mn) of the polycarbonate diol is 500 to 5000.

5. The polyurethane resin according to claim 1, wherein in formula (A), R₁ is butylene or hexylene.

6. The polyurethane resin according to claim 1, wherein in formula (B), R₂ is a C2-3 alkylene group.

7. The polyurethane resin according to claim 1, wherein in formula (B), A is

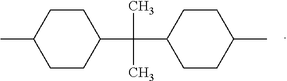

8. The polyurethane resin according to claim 1, wherein in formula (B), 1≤m+n≤10.

9. The polyurethane resin according to claim 1, wherein the repeating unit of formula (B) accounts for 14.5 mol % to 25 mol % of the polycarbonate diol.

10. A polyurethane film, made of the polyurethane resin according to claim 1, and an elastic modulus of the polyurethane film is greater than 90 MPa.

11. A polyurethane film, made of the polyurethane resin according to claim 2, and an elastic modulus of the polyurethane film is greater than 90 MPa.

12. A polyurethane film, made of the polyurethane resin according to claim 3, and an elastic modulus of the polyurethane film is greater than 90 MPa.

13. A polyurethane film, made of the polyurethane resin according to claim 4, and an elastic modulus of the polyurethane film is greater than 90 MPa.

14. A polyurethane film, made of the polyurethane resin according to claim 5, and an elastic modulus of the polyurethane film is greater than 90 MPa.

15. A polyurethane film, made of the polyurethane resin according to claim 6, and an elastic modulus of the polyurethane film is greater than 90 MPa.

16. A polyurethane film, made of the polyurethane resin according to claim 7, and an elastic modulus of the polyurethane film is greater than 90 MPa.

17. A polyurethane film, made of the polyurethane resin according to claim 8, and an elastic modulus of the polyurethane film is greater than 90 MPa.

18. A polyurethane film, made of the polyurethane resin according to claim 9, and an elastic modulus of the polyurethane film is greater than 90 MPa.
